(19) United States
(12) Patent Application Publication
(10) Pub. No.: US 2012/0187150 A1
(43) Pub. Date: Jul. 26, 2012

(54) PSS! Personal Surface Sanitizer

(76) Inventor: Mark Glasmann, Tolleson, AZ (US)

(21) Appl. No.: 13/351,663

(22) Filed: Jan. 17, 2012

Related U.S. Application Data
(60) Provisional application No. 61/461,250, filed on Jan. 14, 2011.

(51) Int. Cl. B67D 7/84; B65D 88/54

(52) U.S. Cl. 222/175; 222/321.7

(57) ABSTRACT

The PSS!! Personal Surface Sanitizer is a specially designed disinfectant solution conveniently packaged in a compact pump dispenser, containing an environmentally friendly disinfecting, antibacterial and viral solution, formulated to kill germs and bacteria on contact packaged in a convenient, portable recycled plastic spray bottle.

### CLAIM OF PRIORITY

This patent application claims priority under 35 USC 119 (e) (1) from U.S. Provisional Patent Application Ser. No. 61/461,250 filed Jan. 14, 2011, of common inventorship herewith entitled, “PSS! Personal Surface Sanitizer.”

### FIELD OF THE INVENTION

The present invention pertains to the field of disinfectants, and more specifically to the field of portable personal spray disinfectants.

### BACKGROUND OF THE INVENTION

The prior art has put forth several designs for personal disinfectants. Among these are:

U.S. Pat. No. 7,178,696 to Douglas P. Larsen, Paul J. Christensen, and Gary L. Pellegrino describes a portable spray dispenser with a non-retractable clip secured to the spray head or container.

U.S. Pat. No. 5.927,548 to James Villaveces describes a body-worn dispenser with an alcohol-glycerin disinfecting gel, for use by doctors and nurses.

U.S. Pat. No. 5,683,012 to James Villaveces describes a body-worn dispenser for an alcohol-glycerin disinfecting gel with additional embodiments, for use by doctors and nurses.

None of these prior art references describe the present invention.

### SUMMARY OF THE INVENTION

It is an object of the present invention to provide a simple and effective means of disinfecting public surfaces with a disinfectant solution packaged in a portable pump dispenser.

### BRIEF DESCRIPTION OF THE DRAWINGS

FIG. 1 is a front view of the device of the present invention comprising a personal surface sanitizer with a clip, retractable cord, and a refill cartridge.

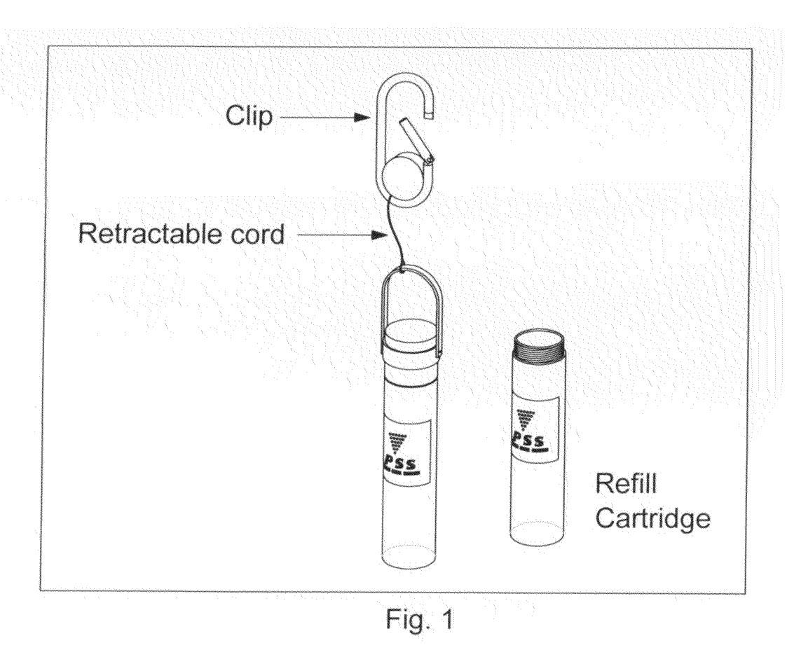

### DETAILED DESCRIPTION OF THE INVENTION

Colds and flu are an unfortunate fact of life. Sore throats, congested noses and throbbing headaches can all result when germs and bacteria infiltrate one's immune system. Communicable illnesses such as the common cold or the flu are highly preventable. Most people don't realize the on-set of these illnesses are the times when they are the most contagious. According to the Center for Disease Control (CDC), the basic steps to preventing these communicable diseases are easily followed. Obviously, the best way to prevent the spread of germs is by avoiding close personal contact with those who are feeling under the weather. As unpleasant as it may seem, being in close proximity when a cold or flu sufferer coughs or sneezes is a major way in which germs are spread from one person to the next. Another important tip for prevention is to wash hands frequently, especially after using the rest room, blowing the nose or rubbing eyes. Unfortunately, not everyone washes their hands on a regular basis, and public establishments such as shopping malls and airports can be a breeding ground for germs and bacteria that cause colds, flu and other communicable diseases. Germs are commonly spread through the most basic of devices such as public telephones, escalator handrails, door knobs and public toilet seats. In particular, public toilet seats are rife with harmful agents. According to a recent report filed by the American Medical Association (AMA), touching a toilet seat just once can leave enough germs and bacteria on the skin that hands must be washed five to six times consecutively, just to get rid of the majority of germs and bacteria. Thriving on hands, these germs and bacteria are also easily deposited onto the legs and buttocks. Realistically, few people have time or even consider showering five or six times after using the rest room. Most public toilet seats are a breeding ground for microscopic fecal coli form, a potentially deadly form of the E. Coli virus. The AMA reports that as many as 25 percent of people leave the bathroom with traces of fecal coli form (usually E. Coli) on their bodies. It has been found that the common cold and influenza are easily transmitted from one person to the next, via the public toilet. The problems associated with exposure to germs and bacteria are not limited to public toilets. The simple act of touching an escalator handrail or utilizing a public telephone can also expose one to these agents. A common scenario is when a busy young mother rushes into a public restroom to change her baby's diaper. After changing the soiled diaper. the woman rushes out of the restroom, forgetting to wash her hands. As the next user exits the restroom, they grab the door handle, unknowingly transferring minute traces of fecal matter, urine and bacteria left behind by the young mother, to their own freshly washed hands. Although extremely unsettling, such scenarios occur every day across the country.

The present invention, hereinafter referred to as the PSS!! Personal Surface Sanitizer is a unique invention which offers consumers a sensible solution to the aforementioned challenges. The PSS!! Personal Surface Sanitizer is a specially designed disinfectant solution conveniently packaged in a compact pump dispenser, enabling users to carry this device with them on the go and treat various surfaces with the disinfectant formula, prior to making direct contact. The PSS!! Personal Surface Sanitizer will contain an environmentally friendly disinfecting, antibacterial and viral solution, formulated to kill germs and bacteria on contact. The most notable aspect of this invention is that the disinfectant is packaged in a convenient, portable spray bottle. Manufactured of recycled plastic material, this unique dispenser comprises a cylindrical shaped barrel measuring approximately six inches in length by one and one-half inches in diameter. A cylindrical shaped cap covers the nozzle between uses. Facilitating easy access on demand, a retractable elastic lanyard is included with the PSS!! Personal Surface Sanitizer to be secured over the unit's dispenser nozzle. Housed in a circular-shaped casing, this retractable spool measures three to seven inches in length, culminating in a spring-loaded clip fastener located on its proximal end. This clip is utilized to secure the PSS!! Personal Surface Sanitizer to a belt loop, purse strap or anywhere else deemed appropriate by the user. For professional use, the PSS!! Personal Surface Sanitizer can be anchored to a number of surfaces by way of the retractable lanyard. The lanyard casing has a self-adhesive backing, enabling the user to adhere the unit to a desk, countertop, toilet tank or common areas. The PSS!! Personal Surface Sanitizer is available individually, and refill bottles are available separately.

Use of the PSS!! Personal Surface Sanitizer is very simple and straight forward. The user simply secures a PSS!! Personal Surface Sanitizer to his belt loop, purse, briefcase, backpack or other easily accessed location for use when needed. Alternately, this device can be mounted to many surfaces. To utilize the PSS!! Personal Surface Sanitizer, the user removes the fitted cap, aiming the dispenser nozzle directly at the surface area the user wishes to disinfect. Before gripping a restroom door handle, a busy executive may first spray the handle with a burst of PSS!! Personal Surface Sanitizer disinfectant, while a mom may disinfect the surface of a public changing table, prior to changing her infant's diaper. Once the designated area is determined, the user simply depresses the unit nozzle and dispenses the solution over the surface area, killing germs and bacteria on contact. After use, the PSS!! Personal Surface Sanitizer is stored away until needed again.

There are many significant benefits and advantages associated with the PSS!! Personal Surface Sanitizer. Foremost, this cleverly designed invention offers consumers a simple and effective means of disinfecting public surface areas. A disinfectant solution conveniently housed in a lightweight and portable dispenser, use of the PSS!! Personal Surface Sanitizer enables consumers to easily treat the germs and bacteria which thrive on publicly utilized objects, prior to making direct contact. Serving to kill harmful germs and bacteria that thrive on toilet seats, this handy solution also can be utilized to spray doorknobs, changing tables or telephones, immediately eliminating germs and bacteria and thus effectively thwarting the spread of these contaminants between users. Preventing the spread of the many harmful agents which often thrive in public places, the PSS!! Personal Surface Sanitizer will protect the user from viruses and communicable illnesses such as the flu, Swine flu and other dangerous infiltrations that can potentially be transferred from one individual to the next. Lightweight and compact, consumers especially will appreciate that the portable PSS!! Personal Surface Sanitizer is easily stored and effortlessly accessed on demand. It can be easily accessed when visiting a grocery store, shopping mall, or even when attending religious services. Environmentally friendly, the PSS!! Personal Surface Sanitizer is dispensed by means of a manual pump, as opposed to a concentrated aerosol dispenser that compromises the environment and ozone layer. Because this product is packaged in recycled and recyclable plastic, use of the PSS!! Personal Surface Sanitizer offers a simple way to “go green.” Easy to use, the PSS!! Personal Surface Sanitizer can be effortlessly dispensed by adults, teens and children alike.

The PSS!! Personal Surface Sanitizer is a practical product invention which provides a simple means of sanitizing public surfaces. Ensuring a safe and hygienic environment for people utilizing public amenities, this invention is an invaluable commodity for any health conscious consumer.

Although this invention has been described with respect to specific embodiments; it is not intended to be limited thereto and various modifications which will become apparent to the person of ordinary skill in the art are intended to fall within the spirit and scope of the invention as described herein taken in conjunction with the accompanying drawings and the appended claims.

1. A portable spray bottle containing an environmentally friendly disinfecting, anti-bacterial and anti-viral solution, packaged in a compact pump spray dispenser having a dispenser nozzle for dispensing the solution, enabling users to carry this device with them and treat surfaces with the disinfecting solution, prior to making direct contact with the surfaces.

2. The spray bottle of claim 1 manufactured of recycled plastic material, and comprises a cylindrical shaped barrel measuring approximately six inches in length by one and one-half inches in diameter, and wherein a cylindrical shaped cap covers the nozzle between uses.

3. The spray bottle of claim 1 further comprising a retractable elastic lanyard wherein the lanyard is secured over the dispenser nozzle, and wherein the lanyard is housed in a circular-shaped casing, and comprises a retractable spool.

4. The spray bottle of claim 3 wherein the lanyard terminates in a spring-loaded clip fastener located on its proximal end, wherein the clip fastener secures the bottle to a belt loop, purse strap or anywhere else deemed appropriate by the user.
